(19) United States
(12) Patent Application Publication
(10) Pub. No.: US 2011/0049999 A1
(43) Pub. Date: Mar. 3, 2011

(54) CIRCUIT FOR CONTROLLING A TUNING GAIN OF A VOLTAGE CONTROLLED OSCILLATOR

(76) Inventor: Yu ZHANG, Shanghai (CN)

(21) Appl. No.: 12/551,496

(22) Filed: Aug. 31, 2009

(51) Int. Cl. H02M 3/06

(52) U.S. Cl. 307/109

(57) ABSTRACT

A circuit is provided that includes a first variable capacitance circuit receiving a first voltage, at least one selectable capacitor bank circuit coupled to the first variable capacitance circuit, at least one multiplexer, the at least one multiplexer coupled to at least one selectable capacitor bank circuit and receiving the first voltage and a second voltage, and a capacitor bank selection circuit coupled to the at least one selectable capacitor bank circuit and the multiplexer.

### TECHNICAL FIELD

Embodiments disclosed herein may be directed to controlling a tuning gain of a voltage-controlled oscillator. In particular, some embodiments may be directed to a circuit which controls the tuning gain of a wide-band voltage-controlled oscillator.

### BACKGROUND

Phase-Locked Loops (PLLs) find application in various contexts where a stable, often high frequency, clock signal is desired. Applications of PLLs include, for example, clock generation for CPUs and for telecommunications. Often, PLLs are required to operate at high frequencies. A typical PLL integrates a phase and frequency detector (“PFD”), a charge pump, a low pass filter, and a voltage-controlled oscillator (“VCO”) in a negative feedback closed-loop configuration. The PFD in a PLL receives a reference clock signal and an internal feedback clock signal and generates two pulsed signals based on the detected phase difference between the reference clock and the internal feedback clock signal. These pulsed signals drive the charge pump to adjust the control voltage provided to the VCO, thereby changing the frequency of the signal output by the VCO.

Typical PLL designs utilize a VCO having wide frequency band. A conventional multi-band VCO 100 is illustrated in FIG. 1. As shown in FIG. 1, VCO 100 includes a capacitor bank selection circuit 108 coupled to a plurality of selectable capacitor banks 102, coupled in parallel. VCO 100 further includes a pair of inductors 104 coupled to selectable capacitor banks 102 at one end of the VCO 100. VCO 100 further includes cross-coupled transistors 106, which provide a positive feedback circuit and presents a negative impedance for the tank circuit formed by inductors 104, selected selectable capacitor banks 102, and continuously tuned variable capacitor pair 110. The frequency band of VCO 100 is determined by selecting selectable capacitor banks 102 by capacitor bank selection circuit 108. Switching the VCO 100 to operate at another tuning band is realized by changing the output logic level of band selection circuit 108 to change the choice of capacitor banks 102. However, as more capacitor banks are added, the tuning gain variation for different frequency bands, or tuning curves, increases. Moreover, operating a VCO over a wide frequency band may result in the unintended variance of other parameters of the PLL, which in turn can degrade the performance of the PLL. Thus, the tuning gain of the VCO is a critical parameter to optimize in PLL designs. For example, controlling the tuning gain of the VCO may change the dynamics of the PLL and also compensate for PLL deviation due to the variation of other parameters.

Consequently, there is a need for controlling the tuning gain of each tuning curve to provide an expected tuning gain for each tuning curve.

### BRIEF SUMMARY

In accordance with some embodiments, there is provided a circuit that can include a first variable capacitance circuit receiving a first voltage; at least one selectable capacitor bank circuit coupled to the first variable capacitance circuit, at least one multiplexer, the at least one multiplexer coupled to at least one selectable capacitor bank circuit and receiving the first voltage and a second voltage, and a capacitor bank selection circuit coupled to the at least one selectable capacitor bank circuit and the multiplexer.

In accordance with some embodiments, there is also disclosed a circuit for controlling a tuning gain of a voltage controlled oscillator (VCO), the circuit including a first variable capacitor circuit, a capacitor bank selection circuit, a plurality of multiplexers coupled to the capacitor bank selection circuit, each multiplexer receiving a first voltage and a second voltage, and being capable of receiving a selection control signal from the capacitor bank selection circuit, and a plurality of selectable capacitor bank circuits, each of the plurality of selectable capacitor bank circuits being coupled to the capacitor bank selection circuit through a corresponding one of the plurality of multiplexers, wherein each of the plurality of selectable capacitor bank circuits comprise a second variable capacitor circuit coupled to the corresponding multiplexer, and a switch capacitance circuit coupled to the second variable capacitor circuit and the capacitor bank selection circuit.

In accordance with some embodiments, there is also disclosed a voltage-controlled oscillator (VCO) having a circuit for controlling a tuning gain of the VCO, the circuit comprising a first variable capacitor circuit, the first variable capacitor circuit comprising a first variable capacitor diode coupled in series to a second variable capacitor circuit, a capacitor bank selection circuit, the capacitor bank selection circuit outputting a selection control signal, a plurality of multiplexers coupled to the capacitor bank selection circuit, each multiplexer receiving a first voltage and a second voltage, and being capable of receiving the selection control signal, and a plurality of selectable capacitor bank circuits, each of the plurality of selectable capacitor bank circuits being coupled to the capacitor bank selection circuit through one of the plurality of multiplexers, wherein each of the plurality of selectable capacitor bank circuits receive the selection control signal and the first or second voltage through the plurality of multiplexers, each of the plurality of selectable capacitor bank circuits including a second variable capacitor circuit coupled to one of the multiplexers, the second variable capacitor circuit including a third variable capacitor diode coupled in series to a fourth variable capacitor diode and receiving the first voltage when the multiplexer receives the selection control signal, and receiving the second voltage when the at least one multiplexer does not receive the select signal, and a switch capacitance circuit coupled to the second variable capacitor circuit and the capacitor bank selection circuit, the switch capacitance circuit comprising a plurality of transistors coupled to the capacitor bank selection circuit, and a plurality of capacitors coupled between the plurality of transistors and the second variable capacitance circuit, wherein, the VCO is capable of having a number of tuning curves (for example about 32 tuning curves), determined by the selection of the selectable capacitor bank circuits, the second variable capacitance circuit of each of the selected selectable capacitor bank circuits determine the tuning gain for each tuning curve, and the tuning gain is determined by the ratio of ΔC/C_{T}, wherein ΔC is the variable capacitance provided by the first variable capacitance circuit and second variable capacitance circuits in the selected selectable capacitor bank circuits, and C_{T} is the capacitance provided by the switch capacitance circuit in the selected selectable capacitor bank circuits and parasitic capacitance presented at VCO outputs.

It is to be understood that both the foregoing general description and the following detailed description are exemplary and explanatory only and are not restrictive of the embodiments disclosed herein. These and other embodiments are further discussed below with reference to the accompanying drawings, which are incorporated in and constitute a part of this specification. These drawings illustrate some embodiments and together with the description, serve to explain the principles of the embodiments disclosed herein.

### BRIEF DESCRIPTION OF THE DRAWINGS

FIG. 1 shows a diagram illustrating a conventional multi-band voltage-controlled oscillator (VCO).

FIG. 2 shows a diagram illustrating a circuit for controlling the tuning gain of a voltage-controlled oscillator (VCO), according to some embodiments.

FIG. 3A shows a graph illustrating the tuning bands, or tuning curves, obtainable using a circuit according to some embodiments disclosed herein.

FIG. 3B shows a graph illustrating the slopes of each of the tuning curves shown in FIG. 3A.

### DETAILED DESCRIPTION OF THE DISCLOSED EMBODIMENTS

Reference will now be made in detail to embodiments disclosed in the accompanying drawings. Wherever possible, the same reference numbers will be used throughout the drawings to refer to the same or like parts.

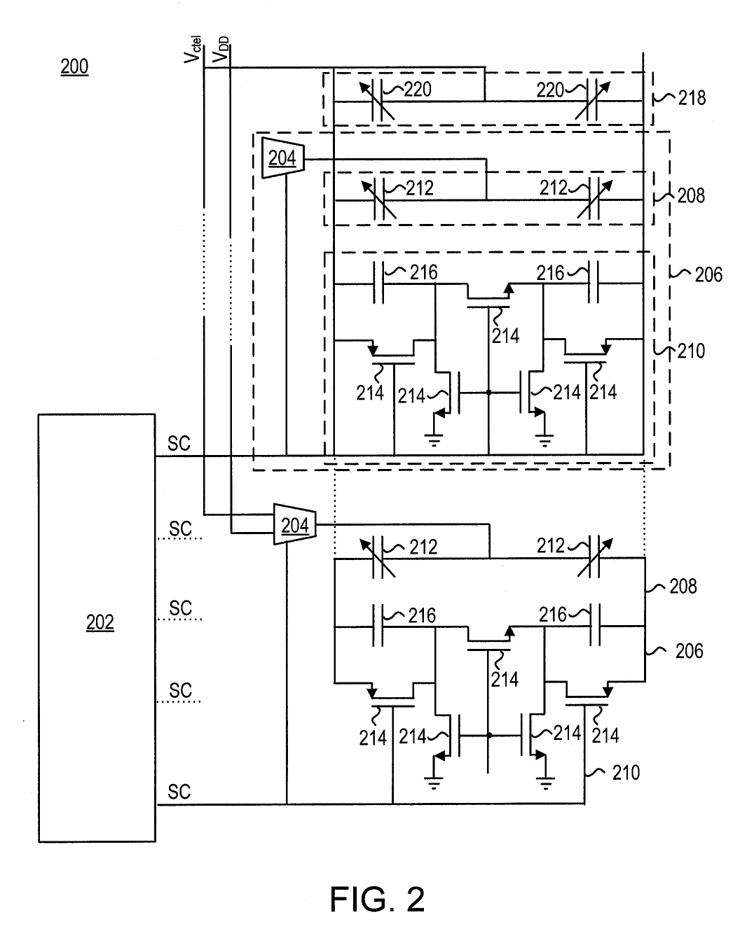

FIG. 2 shows a diagram illustrating a circuit 200 for controlling the tuning gain of a voltage-controlled oscillator (VCO) according to some embodiments. In some embodiments, controlling the tuning gain can be accomplished without adding substantial area to the VCO or consuming additional power.

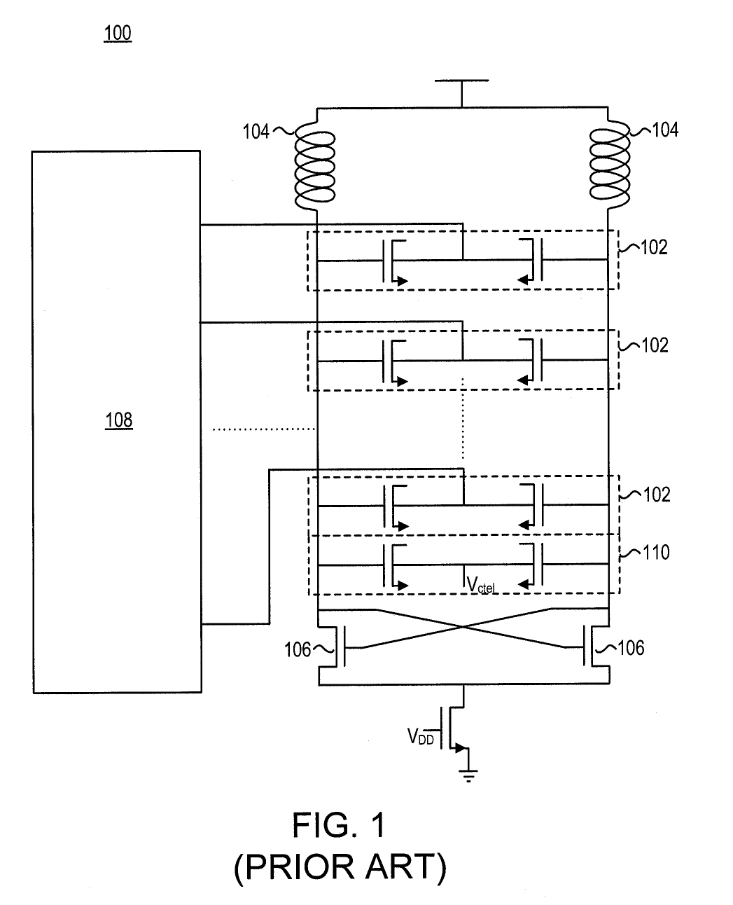

Consistent with some embodiments, circuit 200 may be used in a VCO, for example replacing the conventional capacitor bank shown VCO 100 of FIG. 1. As shown in FIG. 2, circuit 200 includes a capacitor bank selection circuit 202 coupled to a plurality of multiplexers 204 and selectable capacitor bank circuits 206. Consistent with some embodiments, each selectable capacitor bank circuit 206 is coupled to a corresponding multiplexer 204. Capacitor bank selection circuit 202 transmits a selection control signal SC to multiplexers 204 and selectable capacitor bank circuits 206 to activate, or “select,” selectable capacitor bank circuits 206. The selection of selectable capacitor bank circuits 206 determines a dominant oscillation capacitance, and thus tuning curve of frequency band, of a VCO (not shown) in which circuit 200 may be incorporated. According to some embodiments, selection control signal SC may be a digital bus signal.

As shown in FIG. 2, multiplexer 204 is further coupled to a first voltage, control voltage V_{ctrl}, and a second voltage, supply voltage V_{DD}. Consistent with some embodiments, when multiplexer 204 receives selection control signal SC (for example, SC=1), and the corresponding selectable capacitor bank circuit 206 is selected, control voltage V_{ctrl} is passed from multiplexer 204 to selectable capacitor bank circuit 206. However, when multiplexer 204 does not receive selection control signal SC (for example, SC=0), and the corresponding selectable capacitor bank circuit 206 is not selected, supply voltage V_{DD} is passed from multiplexer 204 to selectable capacitor bank circuit 206.

Consistent with some embodiments, selectable capacitor bank circuit 206 includes a variable capacitance circuit 208 and a switch capacitance circuit 210. As shown in FIG. 2, switch capacitor circuit 210 and variable capacitance circuit 208 may be coupled in parallel. Moreover, variable capacitance circuit 208 may be coupled to multiplexer 204 and receive a voltage passed from multiplexer 204, which, as discussed above, may be control voltage V_{ctrl} or supply voltage V_{DD}, depending on whether selectable capacitor bank 206 is selected. Consistent with some embodiments, the voltage passed from multiplexer 204 may provide a bias voltage for variable capacitance circuit 208. Further consistent with some embodiments, switch capacitance circuit 210 may be coupled to capacitor bank selection circuit 202.

Consistent with some embodiments, variable capacitance circuit 208 may include one or more variable capacitance diodes 212 or varactors. As shown in FIG. 2, variable capacitance circuit 208 includes two variable capacitance diodes 212. In accordance with some embodiments, variable capacitance diodes 212 of the selected selectable capacitor banks 206 may provide a variable capacitance for a VCO, thereby providing extra ΔC for a tuning curve. As discussed above, the tuning gain is determined by Δ/C_{T}. More switch capacitance circuit 210 results in larger C_{T}, thus larger ΔC helps to keep the ΔC/C_{T} ratio constant, which helps to keep a constant tuning gain. Furthermore, the ΔC/C_{T} ratio could be altered to other values so that the tuning gain is controllable.

Consistent with some embodiments, and as illustrated in FIG. 2, switch capacitor circuit 210 may include a plurality of transistors 214 coupled to a plurality of capacitors 216. As shown in FIG. 2, switch capacitance circuit 210 includes transistors 214 having their gates coupled to capacitor bank selection circuit 202, and having a source or drain coupled to capacitors 216. In accordance with some embodiments, switch capacitance circuit 210 of the selected selectable capacitor banks 206 may provide both a fixed capacitance and a variable capacitance for VCO 200, thereby determining an operating tuning curve for VCO 200 with a small tuning gain variation.

As also shown in FIG. 2, circuit 200 may include a main variable capacitance circuit 218. Consistent with some embodiments main variable capacitance circuit 218 may be coupled in parallel to the plurality of selectable capacitor bank circuits 206, and may also be coupled to control voltage V_{ctrl}. Moreover, main variable capacitance circuit 218 may include a pair of variable capacitance diodes 220, or varactors.

Consistent with some embodiments, the tuning gain for each tuning curve may be determined by the ratio of ΔC/C_{T}, where ΔC is the variable capacitance provided by variable capacitance circuit 208 in each selectable capacitor bank 206 and main variable capacitance circuit 218, and C_{T} is the total fixed capacitance provided by switch capacitance circuit 210 in each selectable capacitor bank 206 and parasitic capacitance presented at VCO outputs. The values of variable capacitance diodes 212 and fixed capacitors 216 may be chosen such that the tuning gain for each tuning curve may be controlled to be an expected value. This may allow for the control and tuning of the tuning gain of each tuning curve.

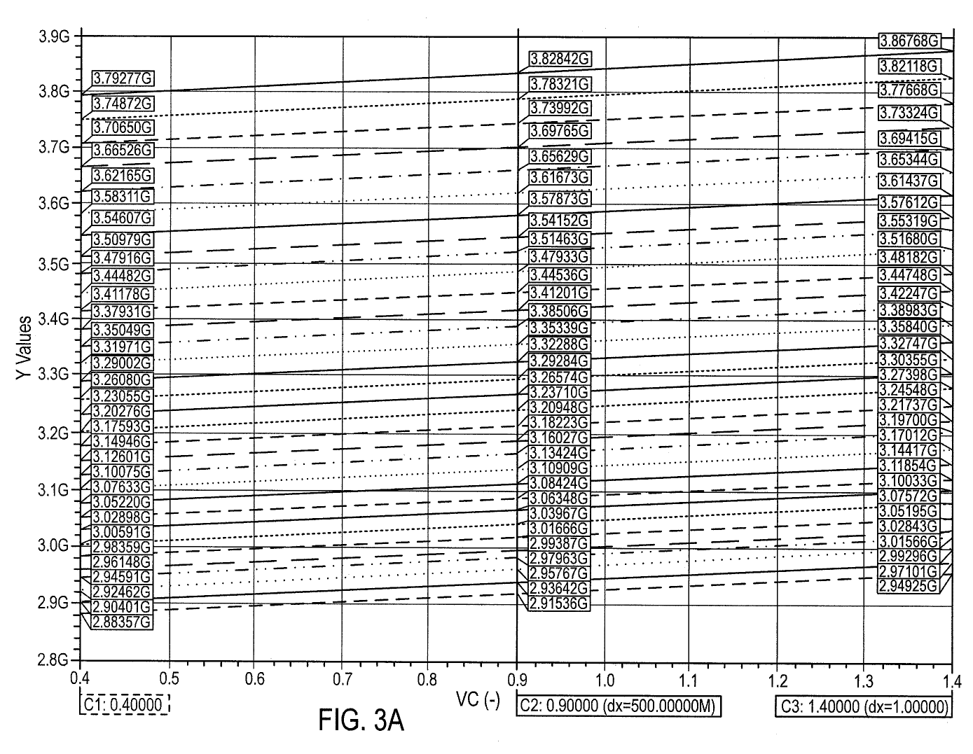

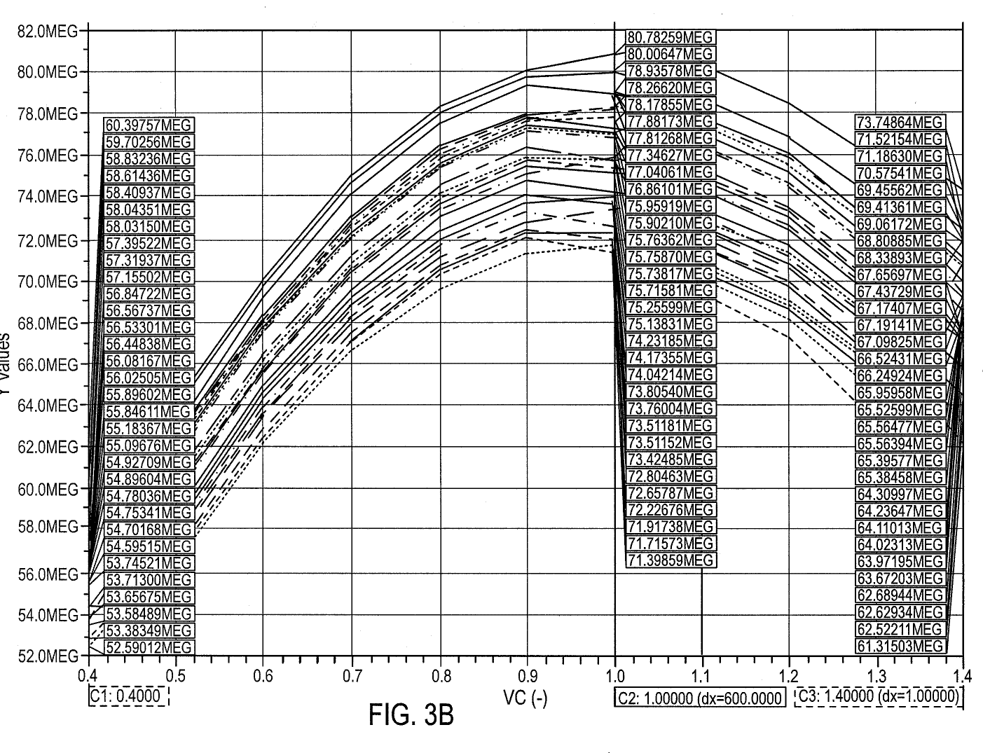

FIG. 3A shows a graph that illustrates the tuning bands, or tuning curves, obtainable using a circuit according to some embodiments disclosed herein, and FIG. 3B shows a graph illustrating the slopes of each of the tuning curves shown in FIG. 3A. FIGS. 3A and 3B illustrate the tuning curves and slopes over an increasing control voltage V_{ctrl}. In FIG. 3A, the Y-values, in GHz, for each of the tuning curves shown is provided at control voltages of 0.4, 0.9, and 1.4. In FIG. 3B, the slopes of the tuning curves shown in FIG. 3A is provided at control voltages of 0.4, 1.0, and 1.4.

As shown in FIG. 3A a VCO using a circuit according to some embodiments as may be disclosed herein are capable of obtaining about thirty-two (32) different tuning bands, or tuning curves. Moreover, as may be apparent from FIGS. 3A and 3B, the tuning gain variation over the 32 tuning curves shown at given V_{ctrl} values may be kept in expected range using a tuning gain control circuit according to some embodiments of the present invention. For example, the slopes at V_{ctrl}=1V (shown in FIG. 3B) changed from 71.4 MHz to 80.78 MHz and this is a small enough variation range for most PLL applications. If traditional methods are employed, this range may be several times larger than the one achieved in FIG. 3B.

Accordingly, some embodiments as disclosed herein may provide a circuit which is able to provide an expected tuning gain over many tuning curves, enabling the precise tuning of a wideband voltage-controlled oscillator. Some embodiments may be apparent to those skilled in the art from consideration of the specification and practice of the embodiments disclosed herein. It is intended that the specification and examples be considered as exemplary only, with a true scope and spirit of the embodiments disclosed herein being indicated by the following claims.

What is claimed is:

1. A circuit, comprising:
a first variable capacitance circuit receiving a first voltage;
at least one selectable capacitor bank circuit coupled to the first variable capacitance circuit;
at least one multiplexer, the at least one multiplexer coupled to at least one selectable capacitor bank circuit and receiving the first voltage and a second voltage; and
a capacitor bank selection circuit coupled to the at least one selectable capacitor bank circuit and the multiplexer.

2. The circuit according to claim 1, wherein the first variable capacitance circuit comprises a first variable capacitance diode coupled in series to a second variable capacitance diode.

3. The circuit according to claim 1, wherein the at least one selectable capacitor bank circuit comprises:
a second variable capacitance circuit coupled to the at least one multiplexer; and
a switch capacitance circuit coupled to the capacitor bank selection circuit and coupled in parallel to the second variable capacitance circuit.

4. The circuit according to claim 3, wherein the at least one selectable capacitor bank circuit comprises a plurality of selectable capacitor bank circuits and the at least one multiplexer comprises a plurality of multiplexers, each of the plurality of selectable capacitor bank circuits being coupled to a corresponding one of the plurality of multiplexers.

5. The circuit of claim 4, wherein the plurality of selectable capacitor bank circuits are coupled to an oscillation circuit, the plurality of selectable capacitor bank circuits being selected by the capacitor bank selection circuit to determine a tuning curve of the oscillation circuit.

6. The circuit of claim 5, wherein the second variable capacitance circuit of the selected selectable capacitor bank circuits and the first variable capacitance circuit determine a tuning gain for each tuning curve of a plurality of tuning curves.

7. The circuit of claim 6, wherein the plurality of tuning curves includes thirty-two (32) tuning curves.

8. The circuit according to claim 3, wherein the second variable capacitance circuit comprises a third variable capacitance diode coupled in series to a fourth variable capacitance diode.

9. The circuit according to claim 3, wherein the switch capacitance circuit comprises:
a plurality of transistors coupled to the capacitor bank selection circuit; and
a plurality of capacitors coupled to the plurality of transistors.

10. The circuit according to claim 1, wherein the at least one multiplexer is coupled to the at least one capacitor bank selection circuit for receiving a selection control signal from the capacitor bank selection circuit.

11. The circuit according to claim 10, wherein, when the at least one multiplexer receives the selection control signal, the at least one selectable capacitor bank circuit is selected and the first voltage biases the second variable capacitance circuit, and when the at least one multiplexer does not receive the selection control signal the second voltage biases the second variable capacitance circuit.

12. The circuit of claim 6, wherein the tuning gain is determined by a ratio of ΔC/C_{T}, wherein ΔC is a variable capacitance provided by variable capacitance diodes in the selected selectable capacitor bank circuits and the continuously tuned variable capacitor pair, and C_{T} is a capacitance provided by capacitors in the selected selectable capacitor bank circuits and parasitic capacitance presented at VCO outputs.

13. A circuit for controlling a tuning gain of a voltage controlled oscillator (VCO), the circuit comprising:
a first variable capacitor circuit;
a capacitor bank selection circuit;
a plurality of multiplexers coupled to the capacitor bank selection circuit, each multiplexer receiving a first voltage and a second voltage, and being capable of receiving a selection control signal from the capacitor bank selection circuit; and
a plurality of selectable capacitor bank circuits, each of the plurality of selectable capacitor bank circuits being coupled to the capacitor bank selection circuit through a corresponding one of the plurality of multiplexers, wherein each of the plurality of selectable capacitor bank circuits comprise:
a second variable capacitor circuit coupled to the corresponding multiplexer; and
a switch capacitance circuit coupled to the second variable capacitor circuit and the capacitor bank selection circuit.

14. The circuit of claim 13, wherein the first and second variable capacitor circuit comprise a first variable capacitor diode coupled in series to a second variable capacitor diode.

15. The circuit of claim 13, wherein the switch capacitance circuit comprises:
a plurality of transistors coupled to the capacitor bank selection circuit; and
a plurality of capacitors coupled to the plurality of transistors.

16. The circuit of claim 13, wherein the plurality of selectable capacitor bank circuits are selected by the capacitor bank selection circuit to determine a tuning curve of the oscillation circuit.

17. The circuit of claim 16, wherein the second variable capacitance circuit of the selected selectable capacitor bank circuits in combine with the first variable capacitance circuit determine the tuning gain for each tuning curve.

18. The circuit according to claim 13, wherein when a multiplexer of the plurality of multiplexers receives the selection control signal the corresponding selectable capacitance bank circuit is selected and the first voltage biases the second variable capacitance circuit of the corresponding selectable capacitor bank circuit, and when the at least one multiplexer does not receive the selection control signal the second voltage biases the second variable capacitance circuit of the corresponding selectable capacitor bank circuit.

19. The circuit of claim 13, wherein the tuning gain is determined by the ratio of ΔC/C_{T}, wherein ΔC is the variable capacitance provided by the second variable capacitance circuit in the selected selectable capacitor bank circuits and the first variable capacitance circuit, and C_{T} is the capacitance provided by the switch capacitance circuit in the selected selectable capacitor bank circuits and parasitic capacitance.

20. A voltage-controlled oscillator (VCO) having a circuit for controlling a tuning of the VCO, the circuit comprising:
a first variable capacitor circuit, the first variable capacitor circuit comprising a first variable capacitor diode coupled in series to a second variable capacitor circuit;
a capacitor bank selection circuit, the capacitor bank selection circuit outputting a selection control signal;
a plurality of multiplexers coupled to the capacitor bank selection circuit, each multiplexer receiving a first voltage and a second voltage, and being capable of receiving the selection control signal; and
a plurality of selectable capacitor bank circuits, each of the plurality of selectable capacitor bank circuits being coupled to the capacitor bank selection circuit through one of the plurality of multiplexers, wherein each of the plurality of selectable capacitor bank circuits receive the selection control signal and the first or second voltage through the plurality of multiplexers, each of the plurality of selectable capacitor bank circuits comprising:
a second variable capacitor circuit coupled to the one of the multiplexers, the second variable capacitor circuit comprising a third variable capacitor diode coupled in series to a fourth variable capacitor diode and receiving the first voltage when the multiplexer receives the selection control signal, and receiving the second voltage when the at least one multiplexer does not receive the select signal; and
a switch capacitance circuit coupled to the second variable capacitor circuit and the capacitor bank selection circuit, the switch capacitance circuit comprising:
a plurality of transistors coupled to the capacitor bank selection circuit;
and a plurality of capacitors coupled between the plurality of transistors and the second variable capacitance circuit, wherein:
the VCO is capable of having about thirty-two (32) tuning curves, determined by the selection of the selectable capacitor bank circuits;
the second variable capacitance circuit of each of the selected selectable capacitor bank circuits determine the tuning gain for each tuning curve; and
the tuning gain is determined by the ratio of ΔC/C_{T}, wherein ΔC is the variable capacitance provided by the second variable capacitance circuits in the selected selectable capacitor bank circuits and the first variable capacitance circuit, and C_{T} is the capacitance provided by the switch capacitance circuit in the selected selectable capacitor bank circuits and parasitic capacitance.
